(19) United States
(12) Patent Application Publication
(10) Pub. No.: US 2011/0312293 A1
(43) Pub. Date: Dec. 22, 2011

(54) NOISE REMOVING APPARATUS

(75) Inventors: Kazuo TAKAYAMA, Kobe-shi (JP); Mai KOUDUKI, Kobe-shi (JP)

(73) Assignee: FUJITSU TEN LIMITED, Kobe-shi (JP)

(21) Appl. No.: 13/075,735

(22) Filed: Mar. 30, 2011

(30) Foreign Application Priority Data
Jun. 21, 2010 (JP) 2010-140868

(51) Int. Cl. H04B 1/10

(52) U.S. Cl. 455/296

(57) ABSTRACT

A noise removing apparatus includes a variable filter with a changeable cutoff frequency and a variable phase shifter with a changeable cutoff frequency, and switches between the variable filter and the variable phase shifter according to a result of detection of noise component. The variable filter has a circuit configuration corresponding to a function in which a transfer function of second or higher degree is represented as a product of primary factors. The transfer function of second or higher degree is calculated based on the phase characteristics of the variable phase shifter.

### CROSS-REFERENCE TO RELATED APPLICATIONS

This application is based upon and claims the benefit of priority of the prior Japanese Patent Application No. 2010-140868, filed on Jun. 21, 2010, the entire contents of which are incorporated herein by reference.

### BACKGROUND OF THE INVENTION

1. Field of the Invention

The present invention relates to a noise removing apparatus that performs noise removal while suppressing the degradation of input signals by using a variable filter and a variable phase shifter in a switchable manner.

2. Description of the Related Art

Conventionally-known noise removing apparatuses suppress the degradation of input signals caused by multipath-noise removal by performing the multipath-noise removal only for sections where the multipath noises are mixed in (see, for example, Japanese Patent Application Laid-open No. S62-175025).

Specifically, the noise removing apparatus described in Japanese Patent Application Laid-open No. S62-175025 takes out an input signal via a first path only when the multipath noise is detected. A variable low-pass filter is arranged in the first path and the multipath noise is removed from the input signal passing through the first path by the variable low-pass filter. On the other hand, the noise removing apparatus described in Japanese Patent Application Laid-open No. S62-175025 takes out the input signal via a second path when the multipath noise is not detected. A variable phase shifter is arranged in the second path.

The variable phase shifter has the same phase characteristics as the variable low-pass filter, so that there would be no phase difference between the signal output from a pre-switching path and the signal output from a post-switching path even when the signal path is switched between the first path and the second path.

In the noise removing apparatus described in Japanese Patent Application Laid-open No. S62-175025, a transfer function which allows the phase characteristics of the variable low-pass filter to coincide with those of the variable phase shifter is calculated as the transfer function of the variable low-pass filter. The circuit configuration of the variable low-pass filter is designed based on the calculated transfer function. Specifically, the variable low-pass filter described in Japanese Patent Application Laid-open No. S62-175025 has a circuit configuration corresponding to a quadratic transfer function represented in a general form.

Further, the noise removing apparatus described in Japanese Patent Application Laid-open No. S62-175025 performs a process to change the cutoff frequency of the variable low-pass filter according to the frequency of the input signal in order to prevent the degradation of the input signal more securely. The cutoff frequency is changed through the change in tap coefficient of the variable low-pass filter.

The noise removing apparatus described in Japanese Patent Application Laid-open No. S62-175025 has a problem that there is a heavy processing load for computing the tap coefficient. Processing load becomes heavy because the circuit configuration of the variable low-pass filter is designed based on the quadratic transfer function represented in a general form and the computing of the tap coefficient is complicated.

When the variable low-pass filter is designed based on the quadratic transfer function represented in a general form, the resulting variable low-pass filter is a quadratic filter with a complicated circuit configuration. Along with the increase in complexity of the circuit configuration of the variable low-pass filter, the degree of complexity in computing the tap coefficient increases. As a result, the processing load for computing the coefficients increases.

Particularly because the noise removing apparatus described in Japanese Patent Application Laid-open No. 552-175025 changes the cutoff frequency based on the frequency of the input signal, the tap coefficient has to be computed frequently. If the computation of tap coefficient entails heavy processing load, the processing speed of the signal processing lowers. This can make a significant influence on the performance of the noise removing apparatus.

In view of the above, it is desirable to realize a noise removing apparatus which can decrease the processing load required for coefficient computation for changing the cutoff frequency of the variable filter.

### SUMMARY OF THE INVENTION

It is an object of the present invention to at least partially solve the problems in the conventional technology.

According to one aspect of the present invention, a noise removing apparatus includes a variable filter with a changeable cutoff frequency, and a variable phase shifter with a changeable cutoff frequency, wherein the variable filter and the variable phase shifter are switched from one to the other according to a result of detection of a noise component, and the variable filter has a circuit configuration corresponding to a function in which a transfer function of second degree or higher is represented as a product of primary factors, the transfer function being calculated based on phase characteristics of the variable phase shifter.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A to 1C are diagrams illustrating an overview of a noise removing apparatus according to the present invention;

FIG. 2 is a block diagram illustrating a configuration of a noise removing apparatus according to an embodiment;

FIG. 3 is a diagram for explaining that the phase characteristics of a variable phase shifter and variable low-pass filter (LPF) coincide;

FIGS. 4A and 4B are diagrams illustrating amplification characteristics and phase characteristics of the variable phase shifter and the variable LPF;

FIG. 5 is a diagram illustrating a digital circuit configurations of the variable phase shifter and the variable LPF; and

FIG. 6 is a diagram illustrating process procedures for determining the digital circuit configurations of the variable phase shifter and the variable LPF.

### DETAILED DESCRIPTIONS

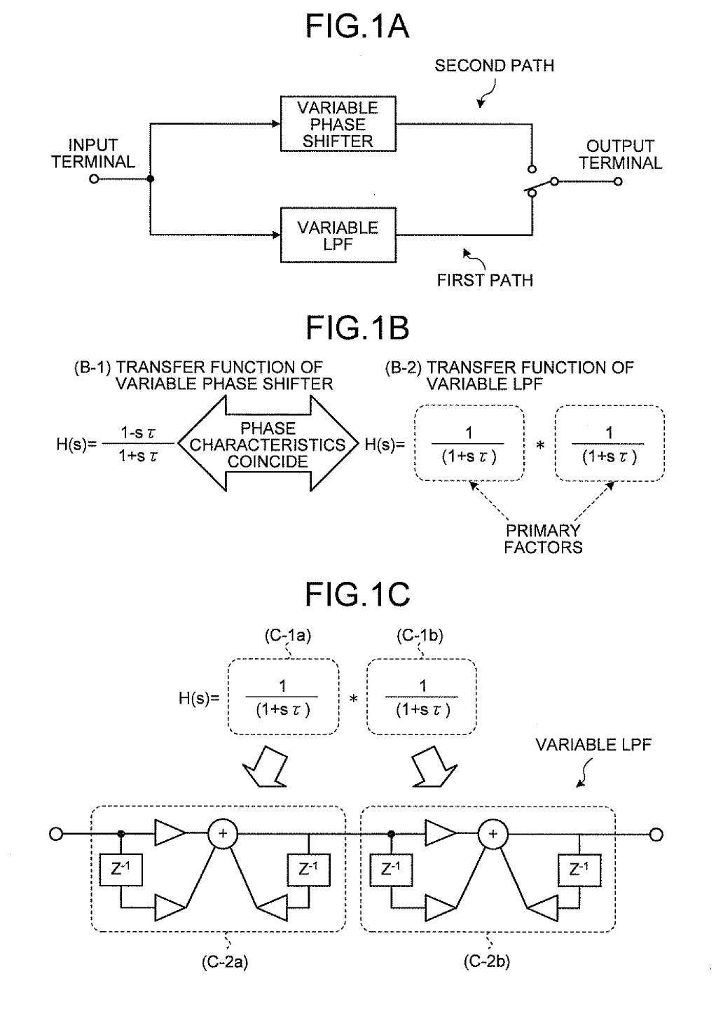

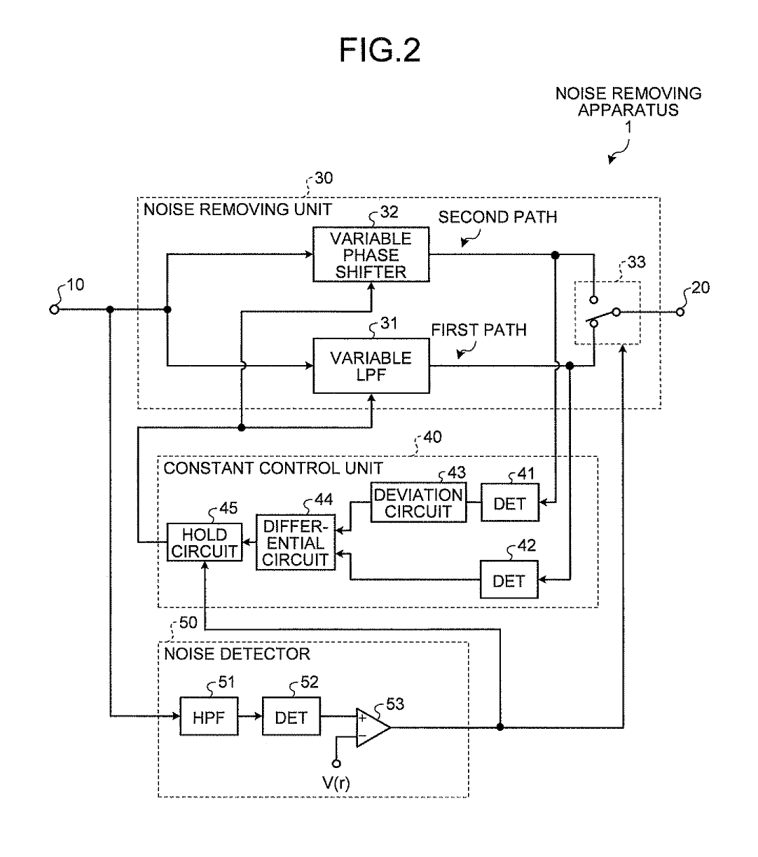

Exemplary embodiments of a noise removing apparatus according to the present invention will be described in detail below with reference to the accompanying drawings. In the following, the overview of the noise removing apparatus according to the present invention is given based on FIGS. 1A to 1C, and then, an embodiment of the noise removing apparatus according to the present invention is described based on FIGS. 2 to 6.

Firstly, before providing a detailed description of the embodiment, an overview of the noise moving apparatus according to the present invention is given based on FIGS. 1A to 1C. FIGS. 1A to 1C are diagrams illustrating an overview of the noise removing apparatus according to the present invention. FIG. 1A illustrates an overall configuration of the noise removing apparatus, FIG. 1B illustrates transfer functions of the variable phase shifter and the variable LPF, and FIG. 1C illustrates a digital circuit configuration of the variable LPF.

As illustrated in FIG. 1A, the noise removing apparatus according to the present invention includes a first path on which a variable low-pass filter (hereinafter “variable LPF”) is arranged and a second path on which a variable phase shifter is arranged. The noise removing apparatus according to the present invention uses these paths by switching between the first and the second paths according to the result of detection of noise components.

More specifically, when the noise components such as multipath noises are detected, the noise removing apparatus takes out an input signal via the first path, in which the variable LPF is arranged. The multipath noises are removed from the input signal by the variable LPF.

The variable LPF is a filter for removing the noise components. In particular, the variable LPF can appropriately remove the multipath noises including a large amount of high-frequency components. Further, the variable LPF can change the cutoff frequency.

On the other hand, when the noise components are not detected, the noise removing apparatus takes out the input signal via the second path on which the variable phase shifter is arranged. The variable phase shifter is a phase shifter which causes the same phase shift as that occurs in the input signal when passing through the variable LPF. The noise removing apparatus, by providing the variable phase shifter in the second path, prevents the phase difference to be generated between the signal output from the pre-switching path and the signal output from the post-switching path when the signal path is switched between the first path and the second path.

In order to make the variable phase shifter cause the same phase shift as that caused by the variable LPF, the phase characteristics of the variable phase shifter have to be made coincide with those of the variable LPF. The noise removing apparatus according to the present invention makes the phase characteristics of the variable phase shifter coincide with those of the variable LPF by calculating the transfer function of the variable LPF based on the phase characteristics of the variable phase shifter, and determining the circuit configuration of the variable LPF based on the calculated transfer function.

More specifically, as illustrated in FIG. 1B, when the transfer function of the variable phase shifter is represented by formula depicted in (B-1) of FIG. 1B, the transfer function of the variable LPF is represented by formula depicted in (B-2) of FIG. 1B. The noise removing apparatus according to the present invention has a feature that it adapts a factorized form including primary factors as the representation of the transfer function of the variable LPF rather than the general form, and determines the circuit configuration of the variable LPF based on the factorized representation of the transfer function.

As illustrated in FIG. 1C, the variable LPF according to the present invention is formed with primary filters connected in series; each primary filter corresponds to the primary factor as illustrated in (B-2) of FIG. 1B. Specifically, the variable LPF is formed with a primary filter (see (C-2a) of FIG. 1C) corresponding to a primary factor illustrated in (C-1a) of FIG. 1C and a primary filter (see (C-2b) of FIG. 1C) corresponding to a primary factor illustrated in (C-1b) of FIG. 1C, connected in series with each other.

Thus, the noise removing apparatus according to the present invention includes a variable LPF which has a circuit configuration corresponding to a quadratic transfer function calculated based on the phase characteristics of the variable phase shifter and represented in a factorized form consisting of primary factors. Hence, the processing load required for computing the coefficients for changing the cutoff frequency of the variable LPF can be reduced.

Conventionally, the circuit configuration of the variable LPF is determined based on the quadratic transfer function expanded into a general form. Hence, the circuit configuration of the variable LPF is that of a quadratic filter, resulting in a complexity in computation of the tap coefficients for changing the cutoff frequency.

On the other hand, when the circuit configuration of the variable LPF is determined based on the transfer function represented in a factorized form consisting of primary factors as in the noise removing apparatus according to the present invention, the variable LPF is configured with primary filters connected in series. As a result, the computation of the tap coefficients can be simplified, and the processing load for coefficient computation can be reduced.

Further, in the noise removing apparatus according to the present invention, the primary filters forming the variable LPF have the same configuration. Hence, one coefficient computation for one primary filter is sufficient for both filters, and the processing load of coefficient computation can be further reduced.

In the following, an embodiment of the noise removing apparatus as described above based on FIGS. 1A to 1C is described in detail. In the following description, it is assumed that the noise removing apparatus removes multipath noises mixed into FM radio waves.

FIG. 2 is a block diagram illustrating a configuration of a noise removing apparatus according to the embodiment. As illustrated in FIG. 2, a noise removing apparatus 1 according to the embodiment includes an input terminal 10, an output terminal 20, a noise removing unit 30, a constant control unit 40 and a noise detector 50. The input terminal 10 is a terminal for receiving an input of an input signal to the noise removing apparatus 1. The output terminal 20 is a terminal for supplying an input signal to the outside of the noise removing apparatus 1.

The noise removing unit 30 is a processor that removes multipath noises mixed into the input signal. The noise removing unit 30 includes a variable LPF 31, a variable phase shifter 32 and a switching circuit 33. The input signal supplied to the input terminal 10 is divided into two paths one for the variable LPF 31 and the other for the variable phase shifter 32. After passing through the variable LPF 31 and the variable phase shifter 32, the input signal is guided to the switching circuit 33.

The constant control unit 40 is a processor which controls the changes in cutoff frequency of the variable LPF 31 and the variable phase shifter 32. More specifically, the constant control unit 40 calculates the tap coefficients of the variable LPF 31 and the variable phase shifter 32 based on the output signal from the variable LPF 31 and the variable phase shifter 32, and sets the calculated tap coefficients to the variable LPF 31 and the variable phase shifter 32. Thus, the cutoff frequencies of the variable LPF 31 and the variable phase shifter 32 are changed.

The constant control unit 40 includes DET circuits 41 and 42 serving as detectors, a deviation circuit 43 that adds a deviation σ to the output of the DET circuit 41, a differential circuit 44 that calculates the difference between the outputs of the DET circuit 42 and the deviation circuit 43, and a hold circuit 45 that holds the output signal of the differential circuit 44. Specific operations of these circuits will be described later.

The noise detector 50 is a processor that detects multipath noises mixed into the input signal. More specifically, the noise detector 50, on detecting the multipath noises, outputs a noise detection signal to the switching circuit 33 and the hold circuit 45.

The noise detector 50 is configured with a HPF (High Pass Filter) 51, a DET circuit 52 that detects the output signal of the HPF 51, and a comparator 53 that compares the output signal of the DET circuit 52 with reference voltage V(r). Specific operations of these circuits will be described later.

The switching circuit 33 switches the signal path between the first path on which the variable LPF 31 is arranged and the second path on which the variable phase shifter 32 is arranged according to the noise detection signal sent from the noise detector 50.

Specifically, the switching circuit 33 switches the path for taking out the input signal to the first path for the sections for which the noise detection signal is received. Thus, the input signal from which the multipath noises have been removed by the variable LPF 31 is taken out from the first path and guided to the output terminal 20.

On the other hand, the switching circuit 33 switches the path for taking out the input signal to the second path for the section for which the noise detection signal is not received. Thus, the input signal for which the noise removal has not been performed is taken out via the second path and guided to the output terminal 20.

The noise removing apparatus 1 employs the variable phase shifter 32 to generate the same phase shift as that caused when the input signal passes through the variable LPF 31 in order to prevent the phase shift in the input signal at the signal path switching. To realize this effect, the variable LPF 31 and the variable phase shifter 32 have to have the same phase characteristics. In the noise removing apparatus 1, the transfer function of the variable LPF 31 is calculated based on the phase characteristics of the variable phase shifter 32, and the circuit configuration of the variable LPF 31 is determined based on the transfer function.

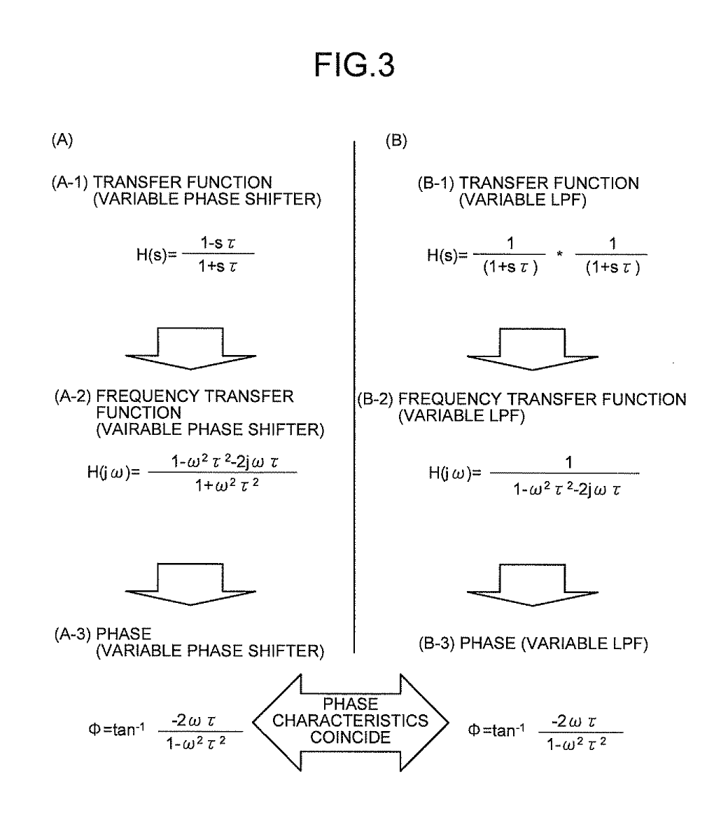

The above feature is described further below with reference to FIG. 3. FIG. 3 is a diagram for illustrating how the phase characteristics of the variable phase shifter 32 are made to coincide with those of the variable LPF 31. Portion (A) of FIG. 3 depicts the transfer function, the frequency transfer function and the phase of the variable phase shifter 32, while portion (B) of FIG. 3 depicts the transfer function, the frequency transfer function and the phase of the variable LPF 31.

As illustrated in (A) of FIG. 3, the transfer function of the variable phase shifter 32 is represented by a formula shown in (A-1) of FIG. 3. In the formula of (A-1), “τ” is a time constant. When s=jω, the frequency transfer function can be represented by the formula shown in (A-2) of FIG. 3. This formula of the frequency transfer function represents the amplitude characteristics of the variable phase shifter 32. In the formula of (A-2), “ω” is angular velocity and ω=2πf (f is cutoff frequency).

When the phase of the variable phase shifter 32 is calculated based on this frequency transfer function, it can be represented by the formula shown in (A-3) of FIG. 3. The phase φ represents the phase characteristics of the variable phase shifter 32.

On the other hand, as illustrated in (B) of FIG. 3, the transfer function of the variable LPF 31 calculated based on the phase characteristics of the variable phase shifter 32 can be represented by the formula shown in (B-1) of FIG. 3. When the frequency transfer function is calculated based on the transfer function H(s), assuming that s=jω, the frequency transfer function can be represented by the formula shown in (B-2) of FIG. 3. Further, when the phase of the variable LPF 31 is calculated based on the frequency transfer function, it can be represented by the formula shown in (B-3) of FIG. 3, which shows that the phase characteristics coincide with the phase characteristics of the variable phase shifter 32.

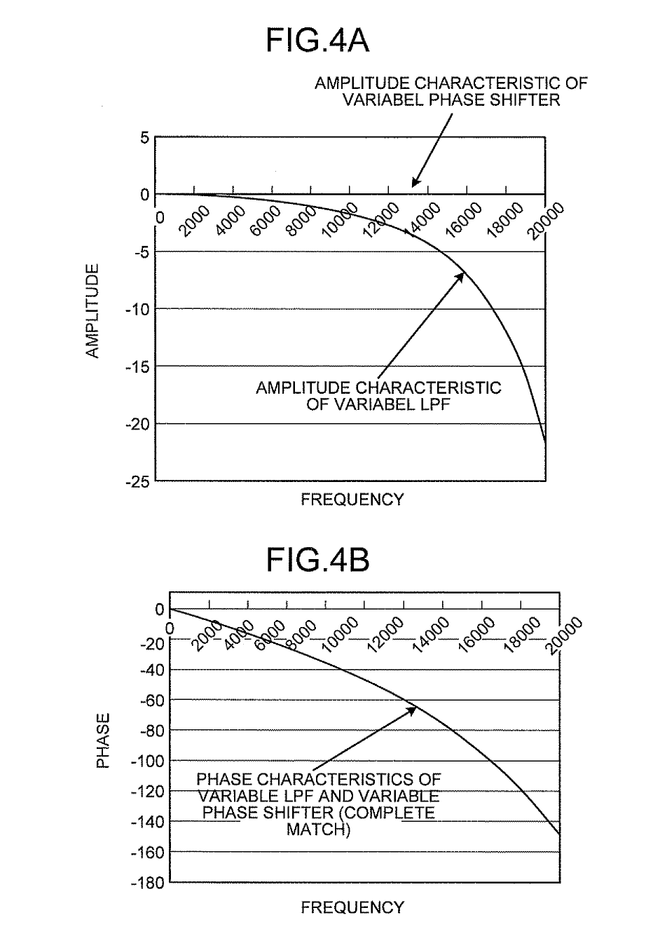

By making the phase characteristics of the variable phase shifter 32 coincide with the phase characteristics of the variable LPF 31 as described above, the phase shift in the input signal at the time of switching between the first path and the second path can be prevented. The amplitude characteristics and the phase characteristics of the variable phase shifter 32 and the variable LPF 31 will be described below with reference to FIGS. 4A and 4B.

FIGS. 4A and 4B are diagrams illustrating the amplitude characteristics and the phase characteristics of the variable phase shifter 32 and the variable LPF 31. The amplitude characteristics and the phase characteristics illustrated in FIGS. 4A and 4B correspond respectively to the frequency transfer function H(jω) and the phase φ illustrated in FIG. 3.

As illustrated in FIG. 4A, the amplitude characteristics of the variable phase shifter 32 are substantially constant over the entire frequency range. Hence, the variable phase shifter 32 can allow the passage of the input signal without degradation thereof. A circuit which changes only the phase of the input signal without changing the amplitude thereof, such as the variable phase shifter 32, is sometimes referred to as “all-pass filter”.

When examining the amplitude characteristics of the variable LPF 31, it can be found that the amplitude decreases as the frequency becomes higher. Thus, it can be known that the variable LPF 31 removes the multipath noises including a large amount of high-frequency components. When the cutoff frequency is changed, the amplitude characteristics of the variable phase shifter 32 remain substantially the same, and only the amplitude characteristics of the variable LPF 31 change.

On the other hand, as illustrated in FIG. 43, the phase characteristics of the variable phase shifter 32 coincide with the phase characteristics of the variable LPF 31 over the entire frequency range. Because the phase characteristics of the variable phase shifter 32 are made to coincide with the phase characteristics of the variable LPF 31 as described above, it is possible when the signal path is switched between the first path and the second path to prevent the phase shift between the input signal output from the pre-switching path and the input signal output from the post-switching path.

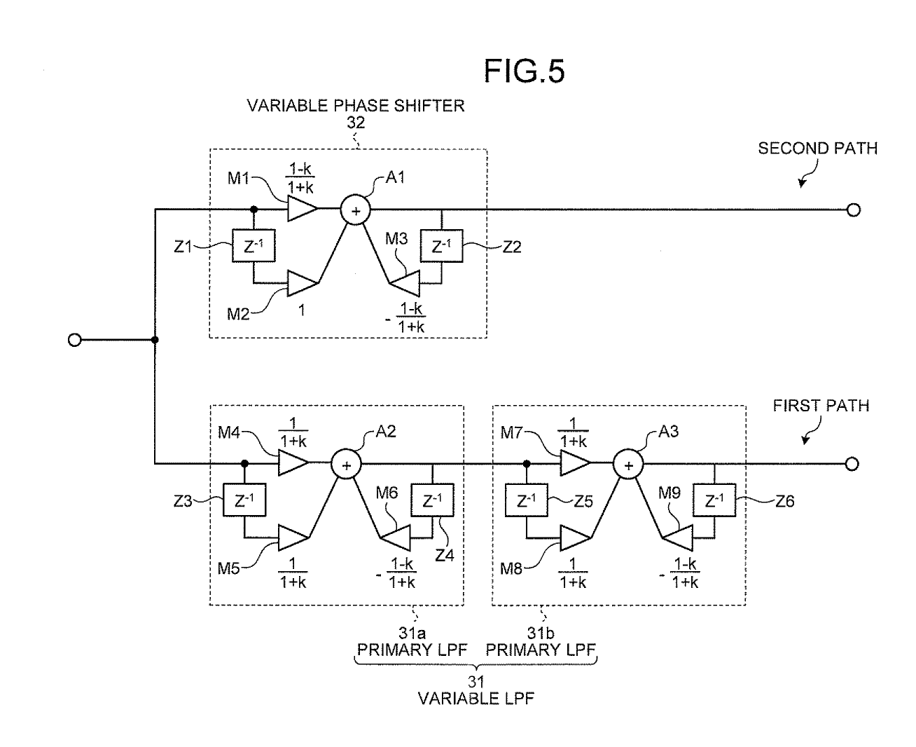

Digital circuit configurations of the variable phase shifter 32 and the variable LPF 31 according to the embodiment will be described with reference to FIG. 5. FIG. 5 is a diagram of the digital circuit configuration of the variable phase shifter 32 and the variable LPF 31.

As illustrated in FIG. 5, the variable phase shifter 32 has a circuit configuration corresponding to the transfer function illustrated in (A-1) of FIG. 3. More specifically, the variable phase shifter 32 is configured as a primary filter including an adder A1, a coefficient multipliers M1 to M3, and delay units Z1 and Z2.

The tap coefficient of the coefficient multiplier M1 is “(1−k)/(1+k)”, the tap coefficient of the coefficient multiplier M2 is “1” and the tap coefficient of the coefficient multiplier M3 is “−(1−k)/(1−k)”.

On the other hand, the variable LPF 31 has a circuit configuration corresponding to the transfer function illustrated in (B-1) of FIG. 3. As illustrated in (B-1) of FIG. 3, the transfer function of the variable LPF 31 according to the embodiment is a rational function of the second degree and represented in an factorized form consisting of primary factors. Hence, the digital circuit configuration of the variable LPF 31 is a configuration including two primary filters connected in series.

More specifically, the variable LPF 31 is configured with primary LPFs 31a and 31b that are primary filters connected in series as shown in FIG. 5. Further, as illustrated in (B-1) of FIG. 3, the primary factors included in the transfer function of the variable LPF 31 are represented by the same formula. Hence, the primary LPFs 31a and 31b that have the circuit configurations corresponding to these primary factors have the same configuration.

More specifically, the primary LPF 31a includes an adder A2, coefficient multipliers M4 to M6 and delay units Z3 and Z4, while the primary LPF 31b includes an adder A3, coefficient multipliers M7 to M9 and delay units Z5 and Z6. Thus, the primary LPFs 31a and 31b have the same configuration.

The tap coefficient of the coefficient multipliers M4 and M7 is “1/(1+k)”, the tap coefficient of the coefficient multiplier M5 and M8 is “1/(1+k)” and the tap coefficient of the coefficient multipliers M6 and M9 is “−(1−k)/(1+k)”.

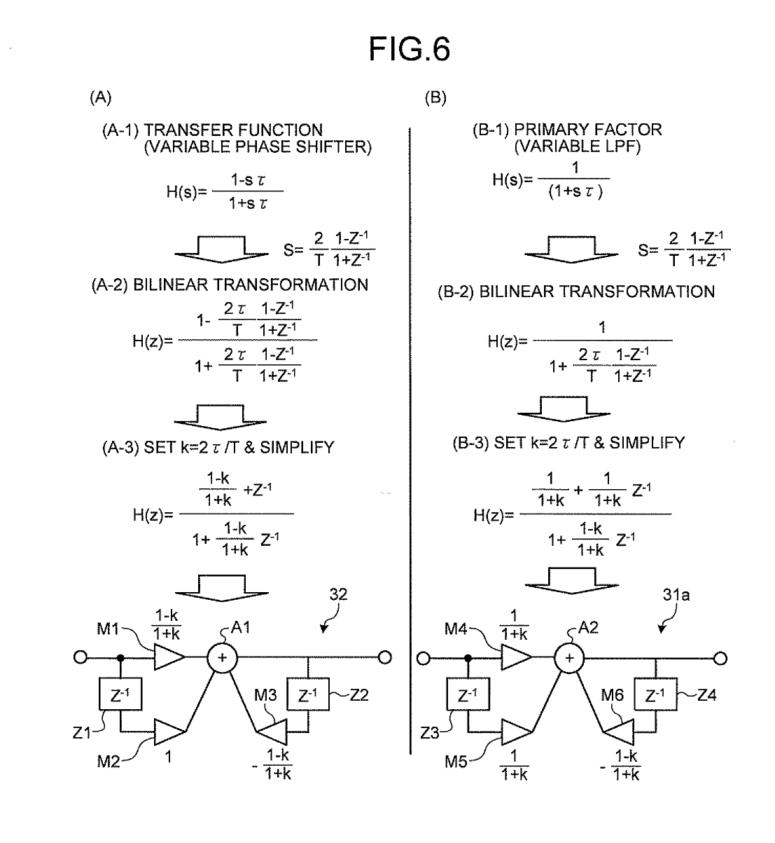

Described next with reference to FIG. 6 is the procedures to determine the digital circuit configuration of the variable phase shifter 32 and the variable LPF 31 illustrated in FIG. 5 based on the transfer function of the variable phase shifter 32 and the transfer function of the variable LPF 31.

FIG. 6 is a diagram illustrating the procedures to determine the digital circuit configuration of the variable phase shifter 32 and the variable LPF 31. In portion (A) of FIG. 6, procedures to determine the digital circuit configuration of the variable phase shifter 32 is illustrated, while in portion (B) of FIG. 6, procedures to determine the digital circuit configuration of the variable LPF 31 is illustrated.

As illustrated in (A) of FIG. 6, when the transfer function of the variable phase shifter 32 (see (A-1) of FIG. 6) is defined as “S={2/T*{(1−Z⁻¹)/(1+Z⁻¹)}, and subjected to bilinear transformation (Z transformation), function illustrated in (A-2) of FIG. 6 can be obtained. In the function of (A-2) of FIG. 6, “T” is sampling time interval. When the function of (A-2) of FIG. 6 is simplified based on the assumption that k=2τ/T, the function as illustrated in (A-3) of FIG. 6 can be obtained. Thus, the digital circuit configuration of the variable phase shifter 32 turns to be the one as illustrated in FIG. 5.

On the other hand, as illustrated in (B) of FIG. 6, when the primary factor in the transfer function of the variable LPF 31 is defined as “S=2/T*{(1−Z⁻¹)/(1+Z⁻¹)}, and subjected to bilinear transformation (Z transformation), the function as illustrated in (B-2) of FIG. 6 can be obtained. Further, when the function as illustrated in (B-2) of FIG. 6 is simplified based on the assumption that k=2τ/T, the function as illustrated in (B-3) of FIG. 6 can be obtained. Thus, the digital circuit configuration of the primary LPF 31a of the variable phase shifter 32 turns to be the one as illustrated in FIG. 5. The digital circuit configuration of the primary LPF 31b is determined according to the similar procedures.

When the cutoff frequency of the variable LPF 31 is to be changed, the tap coefficient of each of the coefficient multipliers M4 to M9 has to be changed. However, the variable LPF 31 is configured such that the primary LPFs 31a and 31b having the same configuration are connected in series as illustrated in FIG. 5. Hence, it is sufficient if the tap coefficients of one primary LPF are computed.

In addition, the tap coefficients of two of the three coefficient multipliers included in the primary LPF are the same. Hence, in practice, it is sufficient if two tap coefficients are computed. More specifically, it is sufficient if “1/1+k” and “−(1−k)/(1+k)” are computed. Still further, because these two tap coefficients include the same term “1+k”, the coefficient computation process can be further simplified. In addition, because the terms such as “1+k” and “1−k” are also included in the tap coefficients of the coefficient multipliers M1 to M3 of the variable phase shifter 32, the overall processing load for the coefficient computation process of the variable phase shifter 32 and the variable LET 31 can be reduced.

As illustrated above, in the present embodiment, the circuit configuration of the variable LPF is made to correspond to the function in which the transfer function of second or higher degree calculated based on the phase characteristics of the variable phase shifter is represented as a product of primary factors. Hence, the processing load for the coefficient computation process for changing the cutoff frequency of the variable LPF can be reduced.

In addition, in the present embodiment, the variable LPF is made to have more than one primary filters having the same circuit configuration. Therefore, the number of coefficients to calculate is reduced. As a result, the processing load for the coefficient computation process can be further reduced.

In the embodiment described above, removal of multipath noises is explained as an example. However, not limited to this example, the noise removing apparatus of the present invention can be applied to the removal of noises other than the multipath noises. In such cases, the variable filter may not be limited to the variable LPF, and may be a variable high-pass filter (HPS), a variable band-pass filter (BPF), or the like.

In the embodiment described above, the transfer function of the variable LPF is explained as a quadratic function (more specifically, rational function of second degree). Not limited thereto, the degree may be third or higher depending on the transfer function of the variable phase shifter forming a pair.

In the following, the operations of the constant control unit 40 and the noise detector 50 illustrated in FIG. 2 will be described. Firstly, the operation of the constant control unit 40 is described.

The input signals output from the variable phase shifter 32 and the variable LPF 31 are detected by the DET circuits 41 and 42, respectively. When the cutoff frequency of the variable LPF 31 is sufficiently higher than the frequency of the input signal, the output level of the DET circuits 41 and 42 are the same value.

On the other hand, a predetermined deviation σ is subtracted from the output of the DET circuit 41 by the deviation circuit 43. Hence, at the input of the differential circuit 44, there is a deviation σ between the output from the deviation circuit 43 and the output from the DET circuit 42, and a control signal corresponding to this deviation σ is sent to the variable phase shifter 32 and the variable LPF 31. Thus, the cutoff frequency of the variable LPF 31 shifts toward low-frequency range.

When an amount corresponding to the deviation σ is removed from the input signal by the variable LPF 31, the output level of the DET circuit 42 comes to coincide with the output level of the deviation circuit 43. As a result, the differential input to the differential circuit 44 becomes zero, and the control signal corresponding to this value is output. As a result, the change to the cutoff frequency of the variable LPF 31 is stopped, and the amplitude characteristics of the variable LPF 31 are maintained. Based on such operations, the cutoff frequency of the variable LPF 31 is constantly controlled to be substantially equal to the fundamental frequency of the input signal.

The cutoff frequency (phase angle) of the variable phase shifter 32 also changes according to the control signal, so that the phase of the input signal shifts by the same amount as the phase shift occurred in the variable LPF 31.

Next, the operation of the noise detector 50 will be described. On receiving the input signal in which the multipath noises are mixed, the noise detector 50 detects the noise components in the input signal and outputs a noise detection signal in a noise-superposing section. In response to the detection signal, the hold circuit 45 holds the characteristics of the variable phase shifter 32 and the variable LPF 31 to those before the noises are generated, and the switching circuit 33 performs input-signal switching.

More specifically, the switching circuit 33 is normally connected to the side of the variable phase shifter 32 so as to transfer the input signal passing through the variable phase shifter 32 to the output terminal 20. When receiving the detection signal from the noise detector 50, the switching circuit 33 is switched to be connected to the side of the variable LPF 31 so as to transfer the input signal passing through the variable LPF 31. Hence, in the section where the noises are generated, the input signal is made to pass through the variable LPF 31 for the removal of multipath noises.

The hold circuit 45 holds the control signal when the noises are detected because the noises appear at the output side of the variable phase shifter 32 while the noises are generated. The operation of the hold circuit 45 prevents the malfunction of the constant control unit 40 caused by such noises.

As can be seen from the foregoing, the noise removing apparatus according to the present invention is useful for reducing the processing load required for coefficient computation process for changing the cutoff frequency of the variable filter; and more specifically is suitable for the application in in-vehicle FM radio receivers.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A noise removing apparatus comprising:
a variable filter with a changeable cutoff frequency; and
a variable phase shifter with a changeable cutoff frequency,
wherein the variable filter and the variable phase shifter are switched from one to the other according to a result of detection of a noise component, and
the variable filter has a circuit configuration corresponding to a function in which a transfer function of second degree or higher is represented as a product of primary factors, the transfer function being calculated based on phase characteristics of the variable phase shifter.

2. The noise removing apparatus according to claim 1, wherein
the variable filter is formed with primary filters respectively corresponding to the primary factors and connected in series.

3. The noise removing apparatus according to claim 1, wherein
the variable filter includes more than one primary filter each having same circuit configuration.
